(19) United States
(12) Patent Application Publication
(10) Pub. No.: US 2006/0117120 A1
(43) Pub. Date: Jun. 1, 2006

(54) Controller to be connected to sender of stream data via IEEE 1394 serial bus

(75) Inventor: Atsushi Takagi, Osaka (JP)

Correspondence Address: CROWELL & MORING LLP;INTELLECTUAL PROPERTY GROUP, P.O. BOX 14300, WASHINGTON, DC, 20044-4300, US

(73) Assignee: FUNAI ELECTRIC CO., LTD., Daito-shi (JP)

(21) Appl. No.: 11/288,147

(22) Filed: Nov. 29, 2005

(30) Foreign Application Priority Data
Nov. 29, 2004 (JP) 2004-343438

(51) Int. Cl. G06F 13/38

(52) U.S. Cl. 710/62

(57) ABSTRACT

When a controller to be connected to a sender of stream data via an IEEE 1394 serial bus cannot decode stream data to be sent from the sender, the controller searches out a device having a data conversion function from a first type of stream data sent from the sender into a second type of stream data which the controller can decode (such device being hereafter referred to simply as “data conversion device”) among the devices on the bus. Thereafter the controller establishes point-to-point connection between the data conversion device and the sender as well as between the data conversion device and the controller, and makes the data conversion device convert the first type of stream data into the second type of stream data.

### BACKGROUND OF THE INVENTION

1. Field of the Invention

The present invention relates to a controller such as a digital television receiving set (hereinafter referred to as “DTV”) and a digital VTR (video tape recorder), which can receive stream data from another device through an IEEE 1394 serial bus.

2. Description of the Related Art

Conventionally, stream data transmitted between devices on an IEEE 1394 serial bus is classified into either DV (digital video) stream data or MPEG (Motion Picture Experts Group) stream data. However, a receiving device (hereinafter referred to as “receiver”) may not be able to decode stream data sent from a sending device (hereinafter referred to as “sender”), because all the devices on the IEEE 1394 serial bus do not have both a decoder for DV stream data (hereinafter referred to as “DV decoder”) and a decoder for MPEG stream data (hereinafter referred to as “MPEG decoder”). For example, when the sender is a DV (digital video) camcorder and the receiver is a DTV, the DTV cannot decode DV stream data sent from a DV camcorder which can generally output only DV stream data, because the DTV does not have a DV decoder.

Japanese Laid-open Patent Publication Hei 11-346345 discloses a digital video recorder that has a data conversion function between MPEG stream data and DV stream data. This digital video recorder receives MPEG stream data, converts the MPEG stream data into DV stream data, and records the converted DV stream data. However, this recorder has a disadvantage of being expensive to manufacture, because the recorder itself has to have a circuit for converting between MPEG stream data and DV stream data.

Japanese Laid-open Patent Publication 2001-218213 discloses a video signal transform coding equipment that is designed to prevent deteriorating image quality in transforming between MPEG stream data and DV stream data. Furthermore, Japanese Laid-open Patent Publication 2001-45091 discloses a data conversion device that has a data conversion circuit comprising a DV decoder and an encoder for MPEG stream data (hereinafter referred to as “MPEG encoder”). However, these technologies shown in Japanese Laid-open Patent Publication 2001-218213 and 2001-45091 have a disadvantage that it costs so much to compose a network, because the network has to include a device exclusively for converting between different types of stream data.

### SUMMARY OF THE INVENTION

An object of the present invention is to provide a controller that is capable of processing stream data sent from the sender normally without being connected to a device exclusively for converting between different types of stream data, even in the case where the controller itself does not have a decoder suited for stream data to be sent from the sender.

According to a first aspect of the present invention, we provide a controller to be connected to a sender of stream data via an IEEE (Institute of Electrical & Electronics Engineers) 1394 serial bus, the controller comprising: an IEEE 1394 interface for sending and receiving control commands and its response signal, and also sending and receiving stream data, to and from devices including the sender via the IEEE 1394 serial bus; a decoder for decoding stream data received by the IEEE 1394 interface; and a microprocessor for controlling the processing of stream data sent from the sender.

When the decoder cannot decode stream data to be sent from the sender, the microprocessor searches out a device having a data conversion function from a first type of stream data sent from the sender into a second type of stream data which the decoder can decode (such device being hereafter referred to simply as “data conversion device”) among the devices on the IEEE 1394 serial bus.

When the microprocessor has been able to search out the data conversion device as a result of the search, the microprocessor establishes point-to-point connection between the data conversion device and the sender as well as between the data conversion device and the controller, and makes the data conversion device convert the first type of stream data sent from the sender into the second type of stream data which the decoder can decode, and thereafter makes the data conversion device send the converted stream data to the controller.

According to this controller, when the decoder of the controller itself cannot decode stream data to be sent from the sender, the data conversion device converts the first type of stream data sent from the sender into the second type of stream data which the decoder of the controller itself can decode, and thereafter sends the converted stream data to the controller. Thus, the controller can process stream data sent from the sender normally without being connected to a device exclusively for converting between different types of stream data, even in the case where the controller itself does not have a decoder suited for stream data to be sent from the sender. In other words, on condition that the data conversion device is connected to the controller via the IEEE 1394 serial bus, the controller itself need not have a decoder suited for stream data to be sent from the sender, and further need not be connected to a device exclusively for converting between different types of stream data. Accordingly, serious cost reducation can be realized in a network including the controller by adopting this controller.

The controller can be designed so that the microprocessor searches out the data conversion device among the devices on the IEEE 1394 serial bus, based on Vendor IDs and Model IDs stored in configuration ROMs of the devices, when the decoder cannot decode stream data to be sent from the sender.

The controller can be designed so that the first type of stream data sent from the sender is digital video stream data, and the second type of stream data which the decoder can decode is MPEG stream data.

The sender can be a digital video camcorder which outputs digital video stream data.

According to a second aspect of the present invention, we provide a controller to be connected to a sender of stream data via an IEEE (Institute of Electrical & Electronics Engineers) 1394 serial bus, the controller comprising: a sending and receiving means for sending and receiving control commands and its response signal, and also sending and receiving stream data, to and from devices including the sender via the IEEE 1394 serial bus; a decode means for decoding stream data received by the sending and receiving means; and a control means for controlling the processing of stream data sent from the sender.

When the decode means cannot decode stream data to be sent from the sender, the control means searches out a device having a data conversion function from a first type of stream data sent from the sender into a second type of stream data which the decode means can decode (such device being hereafter referred to simply as “data conversion device”) among the devices on the IEEE 1394 serial bus.

When the control means has been able to search out the data conversion device as a result of the search, the control means establishes point-to-point connection between the data conversion device and the sender as well as between the data conversion device and the controller, and makes the data conversion device convert the first type of stream data sent from the sender into the second type of stream data which the decode means can decode, and thereafter makes the data conversion device send the converted stream data to the controller.

While the novel features of the present invention are set forth in the appended claims, the present invention will be better understood from the following detailed description taken in conjunction with the drawings.

### BRIEF DESCRIPTION OF THE DRAWINGS

The present invention will be described hereinafter with reference to the annexed drawings. It is to be noted that all the drawings are shown for the purpose of illustrating the technical concept of the present invention or embodiments thereof, wherein:

FIG. 1 is a schematic perspective view showing a DTV according to one embodiment of the present invention that is connected to a DVD recorder, STB, and a DV camcorder;

FIG. 2 is an electrical block diagram showing the DTV and the DVD recorder;

FIG. 3 is an electrical block diagram showing the DV camcorder;

FIG. 4 is a flowchart showing a process performed by the DTV for reproducing and displaying stream data sent from the DV camcorder

FIG. 5 is a tabular view showing the first Self-ID packet to be sent from the devices such as the DVD recorder when the bus is reset.

### DESCRIPTION OF THE PREFERRED EMBODIMENTS

Referring now to the accompanying drawings, the preferred embodiment of the present invention is described. The present invention relates to a controller which is connected to a sender via an IEEE 1394 serial bus and can receive stream data from the sender. In the embodiment described below, the present invention is applied to a digital television receiving set (hereinafter referred to as “DTV”) which has a decoder for MPEG (Motion Picture Experts Group) stream data (hereinafter referred to as “MPEG decoder”) but does not have a decoder for DV (digital video) stream data (hereinafter referred to as “DV decoder”). It is to be noted that the following description of preferred embodiment of the present invention has been presented for purposes of illustration and description, and is not intended to be exhaustive or to limit the present invention to the precise form disclosed.

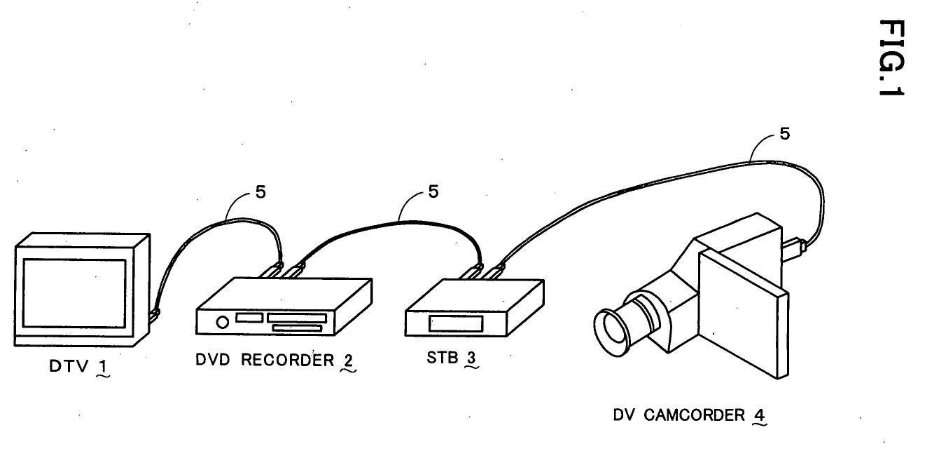

FIG. 1 schematically shows an external view of a DTV 1 (claimed controller) according to this embodiment that is connected to a DVD (digital versatile disc) recorder 2, a STB (set-top box) 3, and a DV (digital video) camcorder 4. The DTV 1 has the MPEG decoder but does not have the DV decoder. Accordingly, the DTV 1 can reproduce and display video images based on DV stream data, but cannot reproduce and display video images based on MPEG stream data. The DVD recorder 2 has ability to convert DV stream data into MPEG stream data. The STB 3 can output MPEG stream data, but cannot output DV stream data. The DV camcorder 4 can output DV stream data, but cannot output MPEG stream data. The DTV 1 and the DVD recorder 2, the DVD recorder 2 and the STB 3, and the STB 3 and the DV camcorder 4 are connected by IEEE 1394 serial bus cables 5. More particularly, the DTV 1, the DVD recorder 2, the STB 3, and the DV camcorder 4 are daisy-chained.

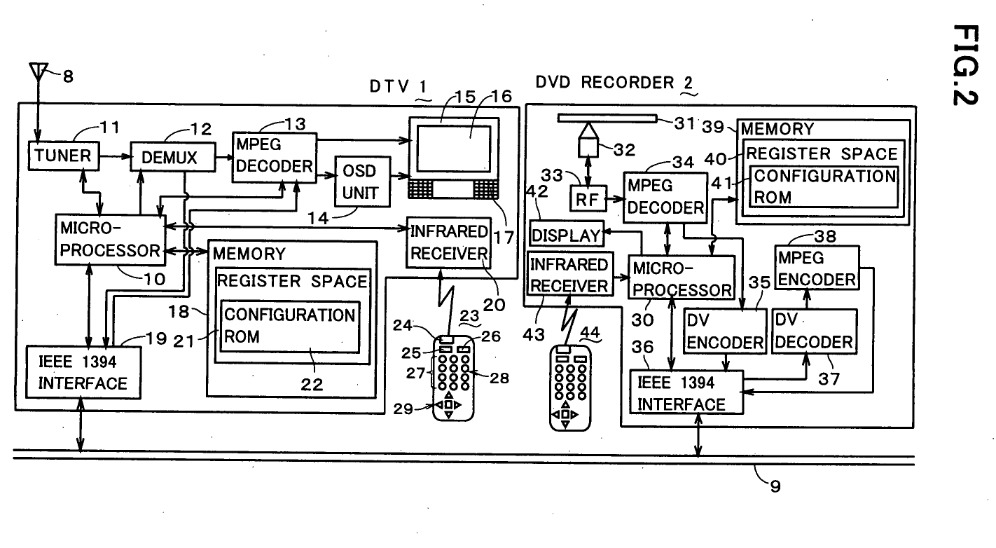

Now, referring to FIG. 2, the electrical configuration of the DTV 1 and the DVD recorder 2 is described. The DTV 1 is connected to an antenna 8. The DTV 1 comprises the tuner circuit (tuner) 11 for receiving digital television broadcasts, a DEMUX (demultiplexer) 12 for extracting video and audio packets of a user-selected program from a transport stream received by the tuner circuit 11, an MPEG decoder (claimed decode means) 13 for decoding MPEG compressed video and audio packets received from the DEMUX 12 to reproduce video and audio signals, an on-screen display unit (hereinafter referred to as “OSD unit”) 14 for superimposing a character data signal or the like on the reproduced video signal, and a monitor 15. The monitor 15 includes a screen 16 for displaying a reproduced video image and a loudspeaker 17 for outputting a reproduced sound. The DTV 1 further comprises a microprocessor 10 (claimed control means) for controlling each component in the DTV 1, a memory 18 for storing various kinds of data, an IEEE 1394 interface (claimed sending and receiving means; hereinafter referred to simply as “interface”) 19 for sending and receiving various kinds of data between the DTV 1 and another device on an IEEE 1394 serial bus 9 (hereinafter referred to simply as “bus”), and an infrared receiver 20 for receiving an infrared signal transmitted from a remote control 23. The memory 18 stores a register space 21 containing various kinds of information concerning the node itself and other nodes on the bus 9. This register space 21 includes a configuration ROM 22 that stores e.g. information about the performance of the DTV 1 itself or the like.

The remote controller 23 has an infrared transmitter 24 and a key portion 28, where arranged are various keys such as a power key 26, numeric keys 27, cursor keys 29, and a menu key 25 for causing various menus to be displayed.

The DVD recorder 2 comprises a microprocessor 30 for controlling each component in the DVD recorder 2. The DVD recorder 2 further comprises: an optical pickup 32 for irradiating a light beam onto the DVD-RAM 31 to record and reproduce data; an RF (radio frequency) circuit (RF) 33 for processing an RF signal output from the optical pickup 32; an MPEG decoder 34 for decoding MPEG stream data output from the RF circuit 33, a DV encoder 35 for encoding the data sent from the MPEG decoder 34 into DV stream data; an IEEE 1394 interface 36 (hereinafter referred to simply as “interface”) for sending and receiving various kinds of data between the DTV 1 and another device on the bus 9. The DVD recorder 2 further comprises a DV decoder 37 for decoding DV stream data sent from another device such as the DV camcorder 4 on a bus 9, an MPEG encoder 38 for encoding the data sent from the DV decoder 37 into MPEG stream data, a memory 39 for storing various kinds of data, a display unit (display) 42 for displaying various messages or the like, and an infrared receiver 43 for receiving an infrared signal transmitted from a remote control 44. The memory 39 stores a register space 40 containing various kinds of information concerning the node itself (DVD recorder 2 itself) and other nodes on the bus 9. This register space 40 includes a configuration ROM 41 that stores e.g. information about the performance of the DVD recorder 2 itself.

The remote control 44 is configured similar to the remote control 23 of the DTV 1, and thus the configuration is not repeatedly described.

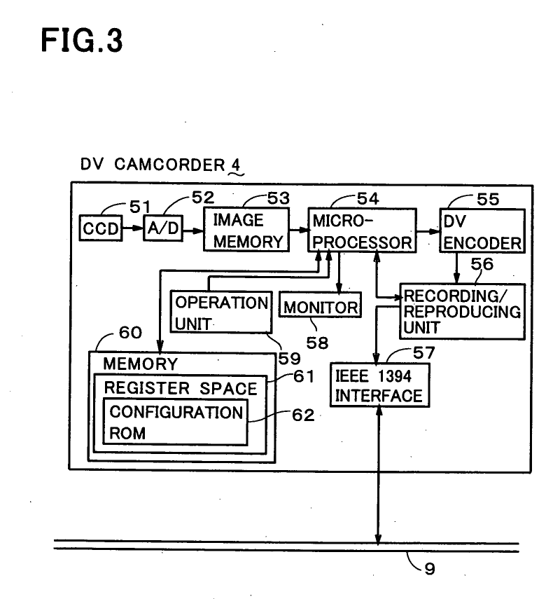

Now, referring to FIG. 3, the electrical configuration of the DV camcorder 4 is described. The DV camcorder 4 is a DV camera with a built-in VCR (video cassette recorder), and comprises an IEEE 1394 interface 57 (hereinafter referred to simply as “interface”) for sending and receiving data such as a control command and stream data to and from an external input/output device such as the DTV 1 and the DVD recorder 2 via the bus 9, a CCD (charge coupled device) 51 for outputting an image of a photographed object in the form of analog signal, an A/D (analog-to-digital) converter 52 for converting an analog signal output from the CCD 51 into a digital signal, an image memory 53 for temporarily storing image data sent from the A/D converter 52, a microprocessor 54 for subjecting the image data stored in the image memory 53 to various image processing, a DV encoder 55, and a recording/reproducing unit 56. The DV encoder 55 encodes the data sent from the microprocessor 54 into DV stream data. The recording/reproducing unit 56 writes, to a DV tape, stream data output from the DV encoder 55, and reproduces stream data (photographed data) recorded on the DV tape. The DV camcorder 4 further comprises a liquid crystal monitor (monitor) 58 for displaying images sent from the microprocessor 54, an operation unit 59, and a memory 60 for storing various data. The memory 60 stores a register space 61 for storing various information on its own node (DV camcorder 4) and other nodes (e.g. the DTV 1 and the DVD recorder 2) on the bus 9. This register space 61 includes a configuration ROM 62 that stores e.g. information about the performance of the DV camcorder 4 itself.

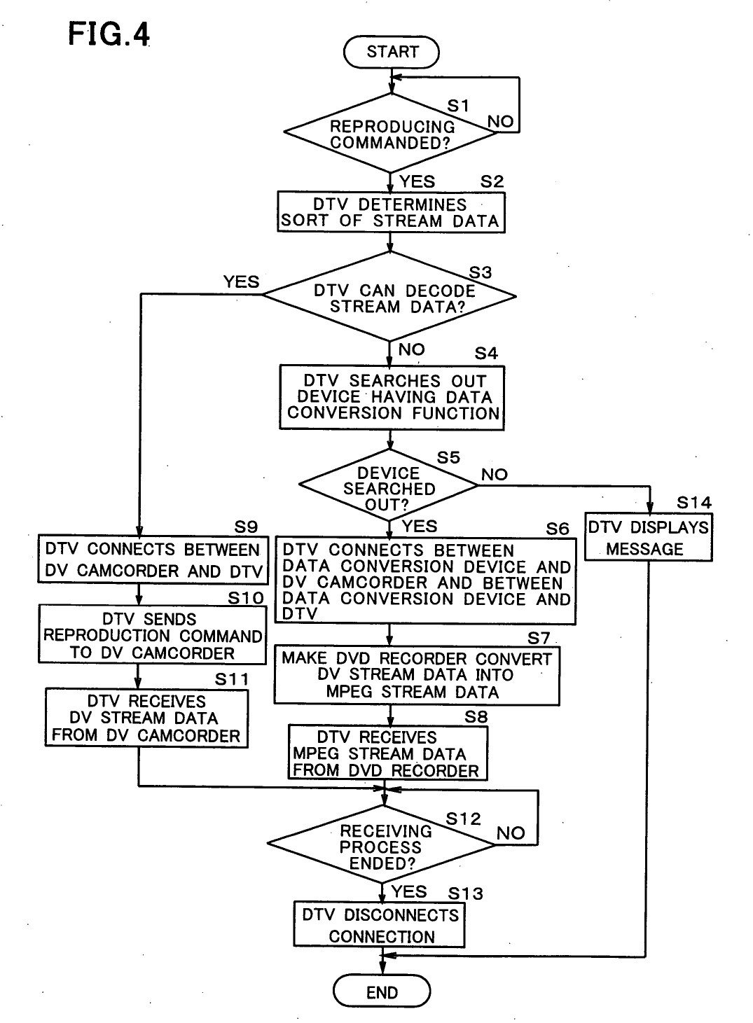

Now, referring to the flow chart of FIG. 4, a process in the DTV 1 for reproducing video and audio based on stream data sent from the DV camcorder 4 will be described. When a user enters a command to make the DV camcorder 4 reproduce the DV tape from the DTV 1 side using the remote controller 23 (YES in S1), the microprocessor 10 of the DTV 1 determines what sort of stream data is sent from the sender (the DV camcorder 4) (S2).

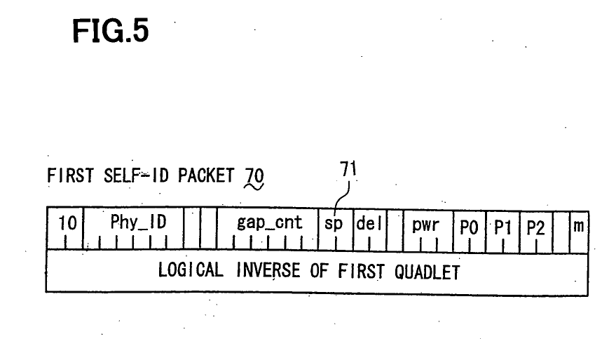

One or two of the following three possible ways can be used for determining the sort of stream data sent from the sender. The first way is to determine the sort of stream data based on the information of the maximum data transfer rate (a sp 71 contained in the first Self-ID packet 70 shown in FIG. 5) of the sender at the physical layer level which is contained in the first Self-ID packet to be sent from the sender when the bus 9 is reset. When the information of the maximum data transfer rate of the sender shows that the maximum data transfer rate is 100 Mbps (megabits per second), the sort of stream data is determined to be DV stream data. On the other hand, when the information of the maximum data transfer rate of the sender shows that the maximum data transfer rate is 400 Mbps, the sort of stream data is determined to be MPEG stream data.

The second way is to determine the sort of stream data based on the information of the subunit type which is contained in the AV/C response frame to be sent from the sender after the DTV 1 sends an inquiry command to the sender. For example, when the information of the subunit type sent from the sender shows that the sender acts as only a tape recorder/player subunit, the sort of stream data is determined to be DV stream data. On the other hand, for example, when the information of the subunit type sent from the sender shows that the sender acts as not only a tape recorder/player subunit but also a tuner subunit, or when the information shows that the sender acts as only a disk recorder/player subunit, the sort of stream data is determined to be MPEG stream data.

The third way is to determine the sort of stream data based on the contents of the output signal register which is contained in the configuration ROM 62 of the sender. Concretely speaking, the DTV 1 inquires about the contents of the output signal register of the sender by sending an AV/C command to the sender. The microprocessor 10 of the DTV 1 determines whether the sort of stream data to be sent from the sender is DV stream data or MPEG stream data based on the contents of the output signal register sent from the sender.

After the determination process of the step S2 ends, the microprocessor 10 of the DTV 1 determines whether the DTV 1 can decode stream data to be sent from the DV camcorder 4, based on both the sort of stream data determined to be sent from the DV camcorder 4 in the step S2 and the sort of the decoder built into the DTV 1 (S3).

When the microprocessor 10 of the DTV 1 determines that the DTV 1 cannot decode stream data to be sent from the DV camcorder 4 as a result of the determination in the step S2 (NO in S3), the microprocessor 10 of the DTV 1 sends an AV/C command to the devices on the bus 9 so as to inquire Vendor IDs (Identifications) and Model IDs of the devices. Thus, the microprocessor 10 of the DTV 1 gets the Vendor IDs and the Model IDs from configuration ROMs of the devices. Based on the Vendor IDs and the Model IDs, the microprocessor 10 of the DTV 1 searches out a device having a data conversion function between DV stream data and MPEG stream data among the devices on the bus 9 (S4). When the sender is the DV camcorder 4 which can output only DV stream data, and the DTV 1 has only the MPEG decoder 13 for decoding MPEG stream data as mentioned above, the device to be searched out in the step S4 is a device having a data conversion function from DV stream data to MPEG stream data.

When the microprocessor 10 of the DTV 1 has been able to search out the device having a data conversion function from DV stream data to MPEG stream data (such the device being hereafter referred to simply as “data conversion device”) as a result of the search in the step S4 (YES in S5), the microprocessor 10 of the DTV 1 establishes point-to-point connection between the data conversion device and the DV camcorder 4 as well as between the data conversion device and the DTV 1(S6).

The above-mentioned connection process will be described more specifically below. The DVD recorder 2 has the data conversion function from DV stream data to MPEG stream data, because the DVD recorder 2 comprises the DV decoder 37 for decoding DV stream data sent from another device such as the DV camcorder 4, and the MPEG encoder 38 for encoding the data decoded by the DV decoder 37 into MPEG stream data. In other words, the DVD recorder 2 is suitable for the above-mentioned data conversion device. Thus, the microprocessor 10 of the DTV 1 establishes point-to-point connection between the DVD recorder 2 and the DV camcorder 4 as well as between the DVD recorder 2 and the DTV 1.

After the connection process of the step S6 ends, the microprocessor 10 of the DTV 1 not only sends a reproduction command to the DV camcorder 4 so as to make the DV camcorder 4 start reproducing the DV tape, but also sends a command to the DVD recorder 2 so as to make the DVD recorder 2 convert DV stream data sent from the DV camcorder 4 into MPEG stream data and thereafter send the converted data to the DTV 1 (S7). Subsequntly the microprocessor 10 of the DTV 1 receives via the interface 19 the converted (MPEG stream) data which is sent from the DVD recorder 2 in response to the above-mentioned command (S8).

If the DTV 1 has a different configuration from one shown in FIG. 2 and can decode DV stream data to be sent from the DV camcorder 4 (YES in S3), the microprocessor 10 of the DTV 1 establishes point-to-point connection between the DV camcorder 4 and the DTV 1 (S9). Subsequently the microprocessor 10 of the DTV 1 sends a reproduction command to the DV camcorder 4 so as to make the DV camcorder 4 start reproducing the DV tape (S10), and thereafter receives via the interface 19 DV stream data which is sent from the DV camcorder 4 in response to the above-mentioned reproduction command (S11).

After the receiving process of the step S8 or the step S11 ends (YES in S12), the microprocessor 10 of the DTV 1 disconnects the point-to-point connection established in the step S6 or S9 (S13).

When the microprocessor 10 of the DTV 1 has not been able to search out the device having a data conversion function from DV stream data into MPEG stream data as a result of the search in the step S4 (NO in S5), the microprocessor 10 of the DTV 1 makes the screen 16 of the monitor 15 display the message (S14) saying “This DTV cannot decode DV stream data sent from the DV camcorder. Please connect to this DTV a device having a data conversion function from DV stream data into MPEG stream data using an IEEE 1394 serial bus cable.”

As described in the foregoing, when the DTV 1 according to the present embodiment cannot decode DV stream data to be sent from the DV camcorder 4, the DTV 1 automatically searches out the data conversion device (e.g. the DVD recorder 2) having a data conversion function from DV stream data into MPEG stream data among the devices on the bus 9, based on the Vendor IDs and the Model IDs stored in the configuration ROMs of the devices on the bus 9. Then the DTV 1 establishes point-to-point connection between the data conversion device and the DV camcorder 4 as well as between the data conversion device and the DTV 1. Subsequently the DTV 1 makes the data conversion device convert DV stream data sent from the DV camcorder 4 into MPEG stream data and thereafter makes the data conversion device send the converted MPEG stream data to the DTV 1. Thus, the DTV 1 can process stream data sent from the DV camcorder 4 normally without being connected to a device exclusively for converting between MPEG stream data and DV stream data via the bus 9, even in the case where the DTV 1 itself does not have a decoder suited for stream data to be sent from the DV camcorder 4. Therefore, according to the DTV 1 of the present embodiment, the DTV 1 itself need not have the decoder suited for stream data to be sent from the DV camcorder 4, and further need not be connected to a device exclusively for converting between MPEG stream data and DV stream data via the bus 9. Accordingly, a serious cost reducation can be realized in a network including the DTV 1 by adopting the DTV 1 of the present embodiment.

It is to be noted that the present invention is not limited to the above-described embodiments, and various modifications are possible. For example, the above embodiment shows the case where the controller according to the present invention is a DTV which can decode only MPEG stream data, and where the sender is a DV camcorder which can output only DV stream data. However, the controller can be a device which can decode only DV stream data, and the sender can be a device which can output only MPEG stream data. Furthermore, the controller can be a device which can decode only MP3 (MPEG-1 Audio Layer 3) data, and the sender can be a device which can output only audio data in the AM824 format as defined in the Audio and Music Data Transmission Protocol.

The present invention has been described above using presently preferred embodiments, but such description should not be interpreted as limiting the present invention. Various modifications will become obvious, evident or apparent to those ordinarily skilled in the art, who have read the description. Accordingly, the appended claims should be interpreted to cover all modifications and alterations which fall within the spirit and scope of the present invention.

This application is based on Japanese patent application 2004-343438 filed Nov. 29, 2004, the contents of which are hereby incorporated by reference.

What is claimed is:

1. A controller to be connected to a sender of stream data via an IEEE (Institute of Electrical & Electronics Engineers) 1394 serial bus, the controller comprising:
an IEEE 1394 interface for sending and receiving control commands and its response signal, and also sending and receiving stream data, to and from devices including the sender via the IEEE 1394 serial bus;
a decoder for decoding stream data received by the IEEE 1394 interface; and
a microprocessor for controlling the processing of stream data sent from the sender,
wherein when the decoder cannot decode stream data to be sent from the sender, the microprocessor searches out a device having a data conversion function from a first type of stream data sent from the sender into a second type of stream data which the decoder can decode (such device being hereafter referred to simply as “data conversion device”) among the devices on the IEEE 1394 serial bus, and
wherein when the microprocessor has been able to search out the data conversion device as a result of the search, the microprocessor establishes point-to-point connection between the data conversion device and the sender as well as between the data conversion device and the controller, and makes the data conversion device convert the first type of stream data sent from the sender into the second type of stream data which the decoder can decode, and thereafter makes the data conversion device send the converted stream data to the controller.

2. The controller according to claim 1,
wherein when the decoder cannot decode stream data to be sent from the sender, the microprocessor searches out the data conversion device among the devices on the IEEE 1394 serial bus, based on Vendor IDs (Identifications) and Model IDs stored in configuration ROMs of the devices.

3. The controller according to claim 2,
wherein the first type of stream data sent from the sender is digital video stream data, and the second type of stream data which the decoder can decode is MPEG (Motion Picture Experts Group) stream data.

4. The controller according to claim 3,
wherein the sender is a digital video camcorder which outputs digital video stream data.

5. The controller according to claim 1,
wherein the first type of stream data sent from the sender is digital video stream data, and the second type of stream data which the decoder can decode is MPEG (Motion Picture Experts Group) stream data.

6. The controller according to claim 5,
wherein the sender is a digital video camcorder which outputs digital video stream data.

7. A controller to be connected to a sender of stream data via an IEEE (Institute of Electrical & Electronics Engineers) 1394 serial bus, the controller comprising:
a sending and receiving means for sending and receiving control commands and its response signal, and also sending and receiving stream data, to and from devices including the sender via the IEEE 1394 serial bus;
a decode means for decoding stream data received by the sending and receiving means; and
a control means for controlling the processing of stream data sent from the sender,
wherein when the decode means cannot decode stream data to be sent from the sender, the control means searches out a device having a data conversion function from a first type of stream data sent from the sender into a second type of stream data which the decode means can decode (such device being hereafter referred to simply as “data conversion device”) among the devices on the IEEE 1394 serial bus, and
wherein when the control means has been able to search out the data conversion device as a result of the search, the control means establishes point-to-point connection between the data conversion device and the sender as well as between the data conversion device and the controller, and makes the data conversion device convert the first type of stream data sent from the sender into the second type of stream data which the decode means can decode, and thereafter makes the data conversion device send the converted stream data to the controller.

8. The controller according to claim 7,
wherein when the decode means cannot decode stream data to be sent from the sender, the control means searches out the data conversion device among the devices on the IEEE 1394 serial bus, based on Vendor IDs (Identifications) and Model IDs stored in configuration ROMs of the devices.

9. The controller according to claim 7,
wherein the first type of stream data sent from the sender is digital video stream data, and the second type of stream data which the decode means can decode is MPEG (Motion Picture Experts Group) stream data.

10. The controller according to claim 9,
wherein the sender is a digital video camcorder which outputs digital video stream data.
